(19) United States
(12) Patent Application Publication
(10) Pub. No.: US 2017/0205108 A1
(43) Pub. Date: Jul. 20, 2017

(54) ENERGY EXTRACTION APPARATUS AND METHOD

(71) Applicants: Vladimir M. PETROVIC, Longmeadow, MA (US); Amirhossein ESHTIAGHI, South Hadley, MA (US)

(72) Inventors: Vladimir M. PETROVIC, Longmeadow, MA (US); Amirhossein ESHTIAGHI, South Hadley, MA (US)

(21) Appl. No.: 15/320,700

(22) PCT Filed: Jun. 19, 2015
(86) PCT No.: PCT/US2015/036730

§ 371 Date: Dec. 20, 2016

Related U.S. Application Data
(60) Provisional application No. 62/016,162, filed on Jun. 24, 2014.

(51) Int. Cl. F24F 12/00; H02K 7/18; F01D 25/24; F01D 15/10

(52) U.S. Cl. CPC F24F 12/00; F01D 15/10; H02K 7/1823; F01D 25/24; F05D 2220/62; F05D 2220/76

(57) ABSTRACT

An energy extraction system located at an off-index run location of a fluid circulation system for harvesting energy in a moving fluid in a conduit, the energy extraction system that includes at least one turbine assembly that includes a housing and a plurality of discs to harvest kinetic energy from the moving fluid, an inlet that receives and directs the moving fluid from the fluid conduit into the turbine housing to drive the plurality of discs and an outlet that returns the moving fluid from the turbine housing to the fluid conduit. The plurality of discs may include an outlet aperture that maximizes a length of a spiral path of contact between the moving fluid and a disc.

### CROSS-REFERENCE TO PRIOR APPLICATION

This application claims priority to and the benefit of U.S. Provisional Patent Application No. 62/016,162, filed on Jun. 24, 2014, titled “Energy Extraction Apparatus and Methods,” the entirety of which is incorporated by reference herein.

### BACKGROUND OF THE DISCLOSURE

1.0 Field of the Disclosure

The present disclosure relates generally to an apparatus arranged to extract kinetic energy from fluids commonly circulated in HVAC, water, natural gas or similar building systems or any other piping distribution system.

2.0 Related Art

Heating, ventilation, and air conditioning (HVAC) systems regulate the temperature in an enclosed environment by circulating heated or cooled working fluids to heat exchangers arranged throughout the space. Fans typically circulate air through the heat exchangers to produce heated or cooled/dried air. The basic concept behind an HVAC system is to move thermal energy between the enclosed space and the outside environment to control conditions within the enclosed space. A multitude of devices may be utilized to accomplish the heat-moving function required for an HVAC system. Terminal units, heat exchangers, chillers, air handling units (AHU), dedicated outdoor air system (DOAS), forced draft boilers, unit heaters, fan coil units (FCU) and duct furnaces are a few examples of devices which supply hot or cold air for a given HVAC system. Regardless of the specific device utilized to control the temperature and humidity in an enclosed space, AC or DC powered motors traditionally drive one or more fans to move the air through the HVAC system and/or across heat exchangers.

HVAC systems are expensive to run and maintain and can represent a large portion of the operating cost of a facility. Utilizing AC or DC motors to move air through an HVAC system negatively impacts the coefficient of performance, an indication of energy efficiency that compares the heating or cooling output to the energy consumed. Moreover, the intricate electrical wiring and electrical infrastructure necessary to manipulate the HVAC system requires skilled labor and frequent maintenance.

Almost every building, whether it is residential, commercial, industrial, institutional or health care, will have a potable (domestic) water circulation system, at least one HVAC system, and possibly an additional heating system. Other fluid circulation systems not listed here are also relevant to the disclosed concepts and embodiments for energy harvesting. Existence of those systems in buildings provides an opportunity to harvest kinetic energy already available in those fluids.

Fluid circulation systems are typically designed to meet a specified maximum demand for fluid flow at a known pressure and volume. There is typically one leg or branch of the fluid circulation system that will place the greatest demand on the fluid circulation equipment and that leg or branch is called the “index run” of the system. In HVAC systems for example, it is common for the index run to extend to the furthermost floor serviced by the particular fluid circulation loop and be designed to provide sufficient fluid circulation to heat or cool every space attached on that floor as though every unit were simultaneously calling for heating or cooling as well as a safety factor. It is apparent that such fluid circulation systems are typically providing far more fluid circulation capacity than is being used at any particular moment. This presents an opportunity to harvest kinetic energy from the fluid circulating in such systems.

The public education system is advanced in areas of information technology, basic physics and chemistry, mathematics and languages but there is a paucity of educational opportunity to study the intricacies of fluid dynamics and energy regeneration.

In view of the above, there is a need for an apparatus that can simply and reliably harvest some of the energy present in fluids circulated in buildings, industrial, HVAC, utility and other systems. The apparatus should be simple, robust and have minimal or no impact on the design and function of the existing fluid circulation systems. The apparatus should be compatible with fluid circulation systems, and built in accordance to relevant standards and codes, allowing the energy harvesting apparatus to be retrofitted to such systems without excess adverse impact on their operation.

Moreover, there is a need for an apparatus that harvests kinetic energy available in fluids and converts it into a rotational speed of a fan to be used with HVAC systems in buildings.

Moreover, there is a need for a novel energy harnessing device that will translate kinetic energy available in the working fluids available in buildings into electrical energy that can be used to drive fans, power control systems and be stored for these and other purposes or supplied into the electric grid.

There is also a need for a kit which can be used to educate students of all levels in the field of fluid dynamics.

### SUMMARY OF THE DISCLOSURE

The present disclosure provides an apparatus and a method for simply and reliably harvesting energy present in fluids circulated in buildings, industrial, HVAC, utility and other systems. The apparatus is simple, robust and has minimal or no impact on the design and function of the existing fluid circulation systems. The apparatus is configured to be compatible with fluid circulation systems and built in accordance to relevant standards and codes, allowing the energy harvesting apparatus to be retrofitted to such systems without adverse impact on their operation.

According to a further aspect of the disclosure, an apparatus and method are provided for capturing kinetic energy available in fluids and converting the energy into a rotational speed of a fan that may be used with HVAC systems in, for example, buildings.

According to a still further aspect of the disclosure, an apparatus and method are provided for harnessing energy that translates kinetic energy in working fluids available in buildings into electrical energy that can be used to drive fans, power control systems and be stored for these and other purposes or supplied into the electric grid.

According to a still further aspect of the disclosure, a kit is provided for educating students of all levels in the field of fluid dynamics and energy regeneration.

In one aspect, an energy extraction system located at off-index run locations of a fluid circulation system for harvesting energy in a moving fluid in a conduit is provided. The energy extraction system comprises at least one turbine assembly that includes a housing and a plurality of discs to harvest kinetic energy from the moving fluid, an inlet that receives and directs the moving fluid from the fluid conduit into the turbine housing to drive the plurality of discs and an outlet that returns the moving fluid from the turbine housing to the fluid conduit, wherein at least one of the plurality of discs comprises an outlet aperture that optimizes a length of a spiral path of contact between the moving fluid and a disc. The at least one turbine assembly may comprise a hub including a plurality of nozzles configured to discharge the moving fluid at a specific location to the plurality of discs and at a specific angle to an axis of rotation of the plurality of discs to maximize turbine efficiency. The turbine housing may comprise a flywheel to provide inertial energy during rotation of the plurality of discs. The moving fluid may comprise water, a glycol, a refrigerant, a crude oil, sewage; gray water, steam, a gas, or any other non-Newtonian fluid. The at least one turbine assembly may comprise at least one Tesla turbine. The at least one turbine assembly may comprises multiple turbines connected in parallel to fully utilize available fluid flow. The at least one turbine assembly may comprise multiple turbines connected in series to fully utilize available fluid pressure head. The at least one turbine assembly may comprise multiple turbines connected in parallel to fully utilize available fluid flow and connected in series to achieve desired pressure drop. At least one of the plurality of discs may have a flat, smooth surface, or at least one of the plurality of discs may have an etched surface depending on the type of fluid being utilized and the value of the associated Reynolds number of the fluid. At least one of the plurality of discs may be a ring with a small outer diameter to inner diameter ratio. Each of the plurality of discs may comprise magnetic elements to maintain the discs in a spaced relationship. The at least one turbine assembly may comprise a shaft that transfers the kinetic energy harvested from the moving fluid to rotational energy. The at least one turbine assembly may comprise a shaft that transfers the kinetic energy harvested from the moving fluid to rotational energy where such shaft comprises of magnetic bearings to maximize efficiency of the turbine assembly. The at least one turbine assembly may comprise at least one nozzle that directs the moving fluid from the inlet to at least one of the plurality of discs to increase a velocity of the moving fluid.

The energy extraction system may further comprise a work-performing device coupled to the shaft and configured to receive the rotational energy. The work-performing device may comprise a fan. The work-performing device may comprise a generator. The work-performing device may comprise any mechanical rotational device, e.g., gears, pulleys, transmission, compressor, or the like.

The circulation system may comprise a building HVAC system and the index run is configured to provide fluid flow to a designated highest pressure loss branch in the piping system, sufficient to meet at least a demand for heating and cooling by every heat exchange unit on that branch.

In one aspect, a method for harvesting energy in a moving fluid in a conduit of a fluid circulation system is provided. The method may comprise identifying an off-index run location of the circulation system for installing an energy extraction apparatus in series with a balancing valve, coupling an inlet of the energy extraction apparatus to a portion of the conduit to receive the moving fluid from the conduit, and coupling an outlet of the energy extraction apparatus to another portion of the conduit to return the moving fluid to the conduit, wherein the energy extraction apparatus comprises a turbine assembly to harness kinetic energy of the moving fluid in the conduit and convert the harnessed kinetic energy to a rotational energy. The turbine assembly may comprise a housing and a plurality of discs configured to harvest kinetic energy from the moving fluid. At least one of the plurality of discs may comprise an outlet aperture that optimizes a length of a spiral path of contact between the moving fluid and a disc. The turbine assembly may comprise a hub including a plurality of nozzles configured to discharge the moving fluid at a specific location to the plurality of discs and at a specific angle to an axis of rotation of the plurality of discs to maximize turbine efficiency. A spacing between the plurality of discs maximizes the contact surface between the moving fluid and the plurality of discs, wherein the spacing is either at the micro-scale or nano-scale.

In one aspect, an energy extraction apparatus for coupling to an off-index run location in series with a balancing valve of a fluid circulation system to harvest kinetic energy of a moving fluid in a conduit is provided. The energy extraction apparatus may comprise at least one turbine assembly that includes a housing and a plurality of discs to harvest kinetic energy from the moving fluid, an inlet that receives and directs the moving fluid from the fluid conduit into the turbine housing to drive the plurality of discs, and an outlet that returns the moving fluid from the turbine housing to the fluid conduit. At least one of the plurality of discs may comprise an outlet aperture that optimizes a length of a spiral path of contact between the moving fluid and a disc. The turbine assembly may comprise a hub wherein the plurality of discs are secured to each other and to the hub in a spaced relationship. The at least one turbine assembly may comprise multiple turbines connected in parallel to fully utilize available fluid flow and/or connected in series to achieve desired pressure drop.

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as any person skilled in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure.

### BRIEF DESCRIPTION OF THE DRAWINGS

The accompanying drawings, which are included to provide a further understanding of the disclosure, are incorporated in and constitute a part of this specification, illustrate embodiments of the disclosure and, together with the detailed description, serve to explain the principles of the disclosure. No attempt is made to show structural details of the disclosure in more detail than may be necessary for a fundamental understanding of the disclosure and the various ways in which it may be practiced. In the drawings, aspects of the present disclosure will be described in reference to the drawings, where like numerals reflect like elements:

FIG. 1 illustrates an embodiment of a turbine powered fan apparatus, according to principles of the present disclosure;

FIG. 2 shows an example of a method for extracting energy, according to principles of the present disclosure;

FIG. 3 shows an exploded view of the turbine of FIG. 1, the fan being omitted for clarity;

FIG. 4A is a drawing of an embodiment of the turbine powered fan apparatus, where the turbine is also connected to an electricity generator;

FIG. 4B is a drawing of an embodiment of the turbine powered fan apparatus where two fans are connected to a single turbine;

FIG. 5 is a schematic diagram of an arrangement of an HVAC system utilizing a turbine powered fan apparatus in accordance with the present disclosure;

FIG. 6 shows several alternative embodiments of a nozzle compatible with the turbine depicted in FIG. 3;

FIG. 7 is a schematic diagram of a control diagram, according to principles of the present disclosure;

FIG. 8 is a schematic of an embodiment of an apparatus in a forced draft boiler application;

FIG. 9 is a perspective view of an embodiment of a Tesla turbine, according to aspects of the disclosure with the end of the housing and some discs removed for clarity;

FIG. 10 is a partial exploded perspective view of an alternative embodiment of a Tesla turbine according to aspects of the disclosure; and

FIG. 11 is a longitudinal sectional view of the Tesla turbine of FIG. 10.

FIG. 12A is a perspective view and FIG. 12B is a cross-sectional view of a rotor embedded in a turbine, configured according to principles of the disclosure.

FIG. 13A illustrates a multi-floor structure with fan coils arranged in parallel, configured according to principles of the disclosure.

FIG. 13B illustrates an alternate embodiment of an multi-floor structure with turbines arranged in parallel, configured according to principles of the disclosure.

FIG. 13C illustrates turbines arranged in parallel, configured according to principles of the disclosure.

FIG. 13D illustrates turbines arranged in series, configured according to principles of the disclosure.

FIG. 13E illustrates turbines arranged both in parallel and series, configured according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “microprocessor” or “microcontroller”, as used in this disclosure, means any machine, device, circuit, component, or module, or any system of machines, devices, circuits, components, modules, or the like, which are capable of manipulating data according to one or more instructions, such as, for example, without limitation, a processor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a storage area network (SAN), a broadband area network (BAN), a cellular network, the Internet, or the like, or any combination of the foregoing, any of which may be configured to communicate data via a wireless and/or a wired communication medium.

The terms “including,” “comprising” and variations thereof, as used in this disclosure, mean “including, but not limited to,” unless expressly specified otherwise

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

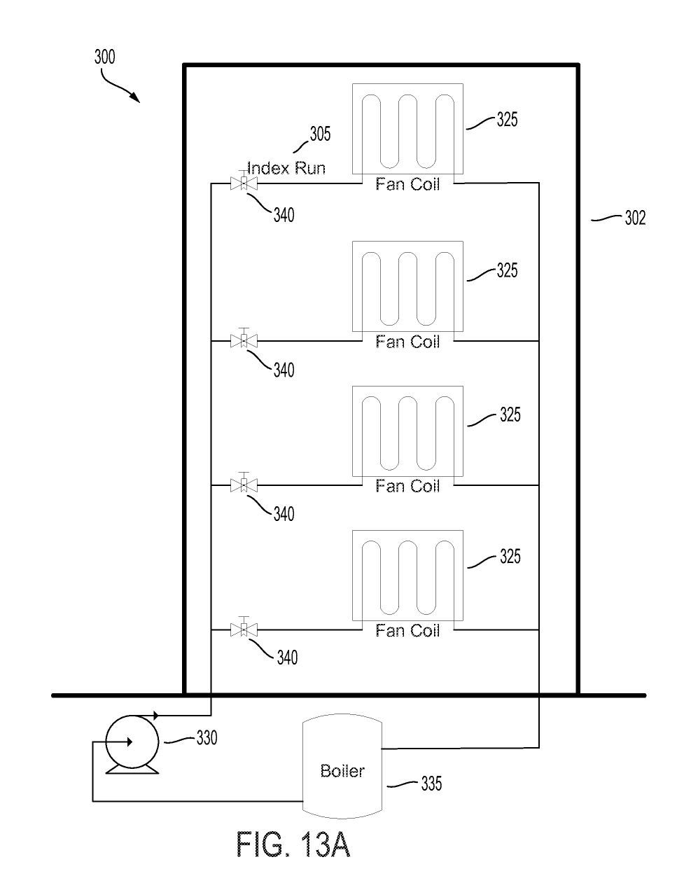

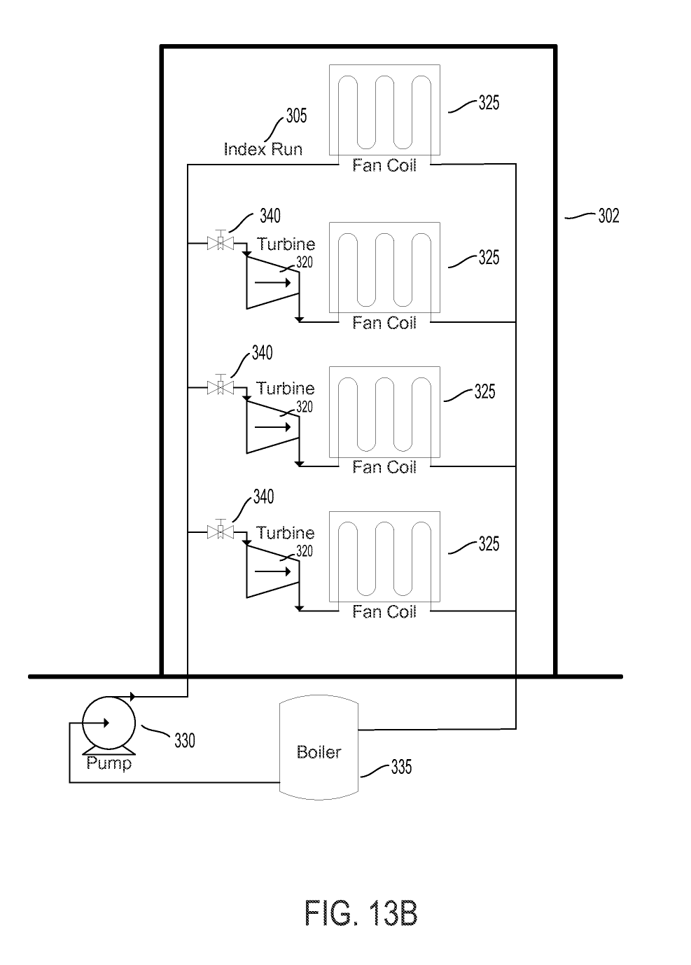

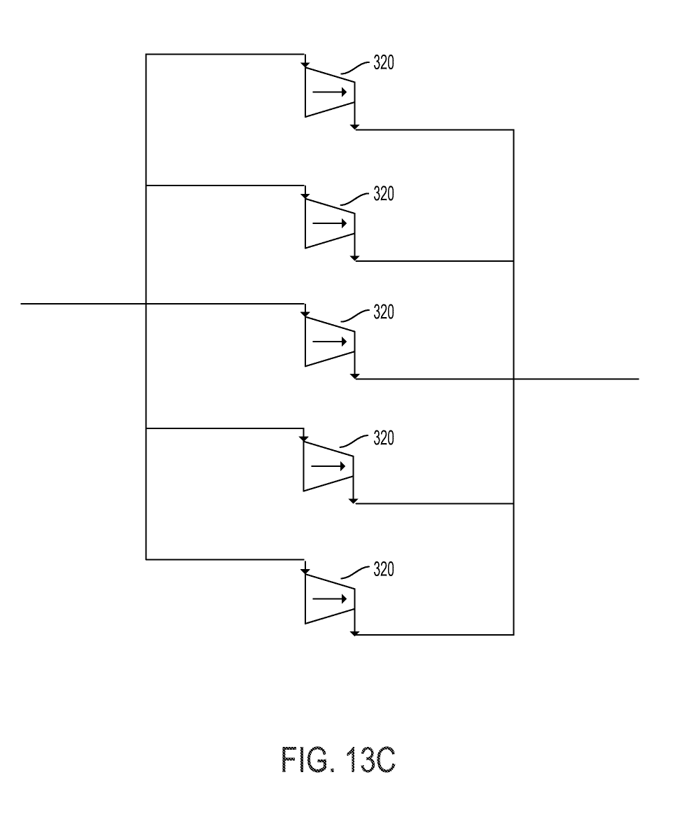

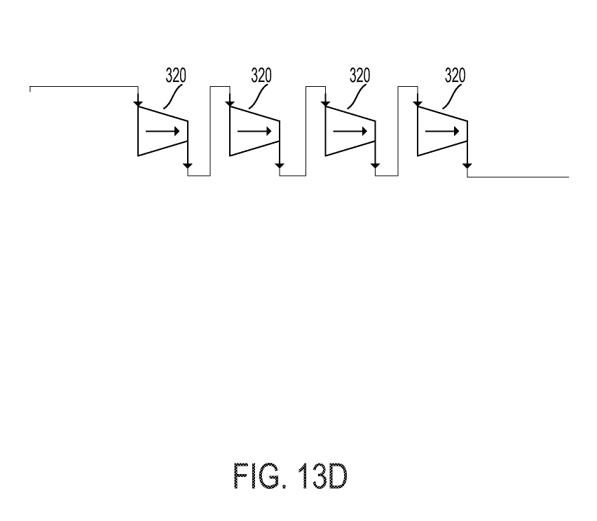

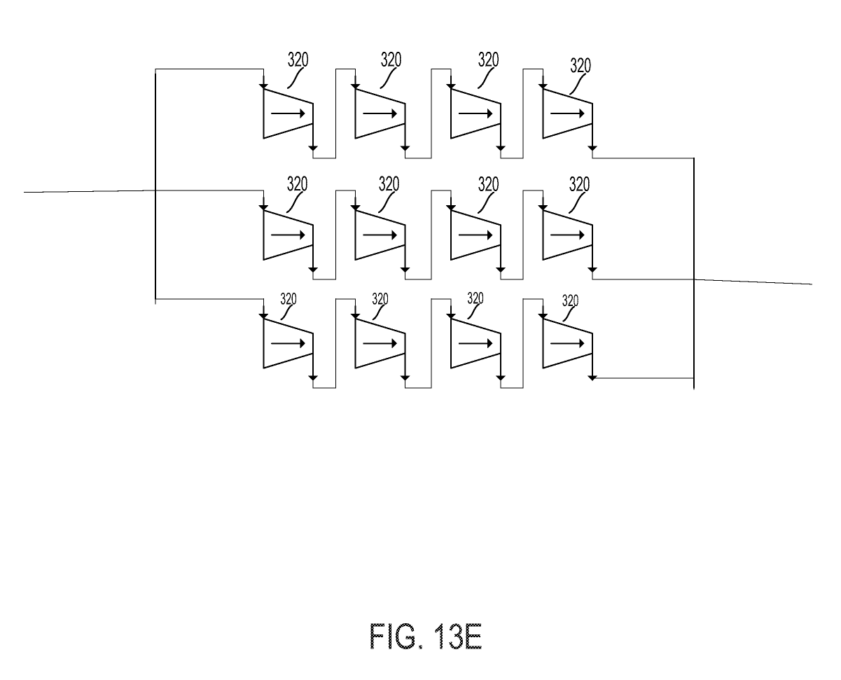

Fluid circulation systems are typically designed with excess capacity resulting in fluid flows from which kinetic energy can be harvested without adversely impacting the overall operation or design of such systems. The principles on which the disclosed apparatus and methods herein are based are illustrated in the context of a non-limiting reference to the HVAC system 300 for a typical multi-floor structure as shown in FIGS. 13A and FIG. 13B. The disclosed apparatus and methods are not limited to HVAC systems and are broadly applicable to any system in which fluid (liquids, gases, mixtures of liquid and gases) circulates or flows.

FIG. 13A illustrates a multi-floor structure 302 with fan coils 325 arranged in parallel, generally denoted by reference numeral 300. The fan coils 325 may be connected to a pump 330 and a boiler 335. Balancing valves 340 on each level may assist the water in going from a lower level to the upper levels in order to create an artificial pressure loss, so that water can continue to travel up the pipes. The index run 305 for HVAC system 300 is typically the most critical path of the fluid flow, typically to a designated “top” floor (which may not be the highest floor in the structure) sufficient to meet a demand for heating or cooling by every unit such as fan coils 325 on that floor plus a safety margin of about 5 to about 30%, e.g., to meet maximum cooling or heating demand from the top floor, which in turn determines overall size and capacity of the pump. A system designed to meet this demand typically has sufficient flow capacity and pressure to meet the demands of all the floors below the top floor. For every floor below the “top” floor of the index run, the pressure and flow available from the index run 300 typically exceeds the demand required for the devices on that floor. In particular, the lower floors of a structure served by such an HVAC system comprise an off-index run and typically have significant excess fluid pressure and flow available, which is then throttled (reduced) to meet the demand on a particular floor. Such throttling or pressure reduction of fluid is typically performed by use of balancing, pressure reducing valves, by means of permanently wasting the available energy contained in the fluid.

According to the principles of the instant disclosure, an apparatus can be installed in the fluid circulation pathway to harvest energy represented by the excess pressure and volume of fluid flowing in parts of the HVAC system 300 other than the index run 305. A non-limiting example of such an apparatus may include a Tesla turbine, the basic configuration of which is well-known. The fluid flow may be directed through one or more nozzles to increase the velocity of the fluid, which may then be directed between the parallel discs of the Tesla turbine to impart rotational force to the discs and shaft of the turbine. The rotation of the shaft can be employed to perform work directly (for example, to turn a fan blade to move air through a heat exchanger) or can be used to turn an electricity generating device. Electrical energy can be used to operate fans, control systems or other purposes, may be stored for later use, or connected back to the electrical grid.

A Tesla turbine is an attractive apparatus because it has the potential to efficiently and reliably harvest kinetic energy from a fluid flow without creating significant turbulence or disruption of the fluid (pressure loss). It will be apparent to those skilled in the art that other devices may be compatible with the disclosed concepts and methods. The disclosures are not limited to any particular harvesting apparatus, and the Tesla turbine is intended as a non-limiting example of an apparatus compatible with the present disclosure.

A small energy harvesting apparatus, such as a Tesla turbine, may be employed to generate electrical energy where needed, thereby eliminating the need to run a separate electrical supply to control system and fan apparatus associated with HVAC sub-units, such as the heat exchangers serving a particular room or portion of a space. This can result in significant savings in terms of construction costs, while the Tesla turbine should also require less maintenance than the typical electric motors used to drive fans and the like in HVAC systems.

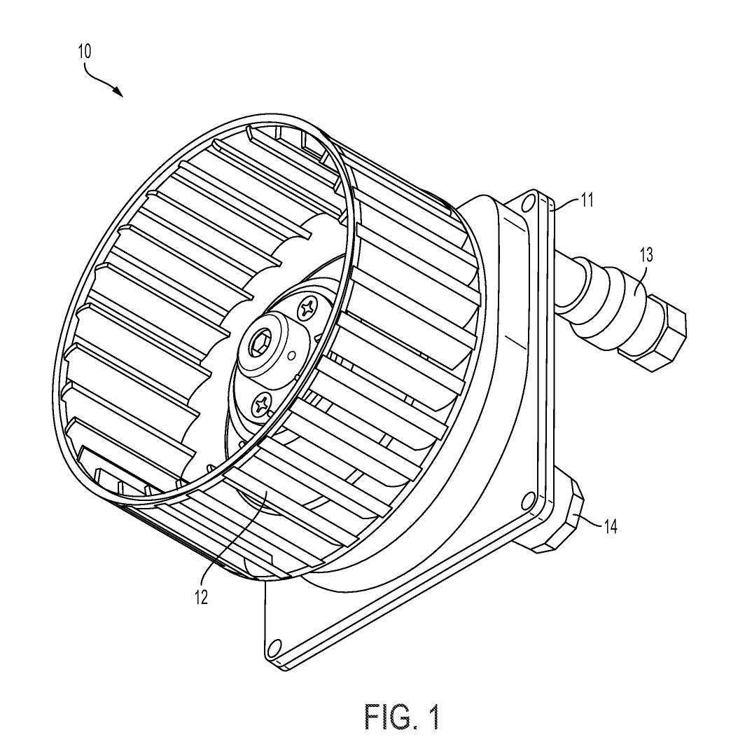

FIG. 1 illustrates an embodiment of a turbine powered fan apparatus 10, according to aspects of the present disclosure. The turbine powered fan apparatus 10 includes a turbine assembly including a housing 11, an inlet 13, and an outlet 14. The term “fan”, as used throughout the disclosure, means an impeller, rotor, or other rotating member such as the squirrel cage impeller 12, with or without a casing, which is typically employed to circulate large volumes of a fluid such as air. HVAC systems typically employ numerous fans to circulate air through heat exchangers to heat and/or cool and dehumidify air in a building. Each fan is typically provided with electrical power via conductors connected to the building electrical supply and controlled by thermostats or other control system.

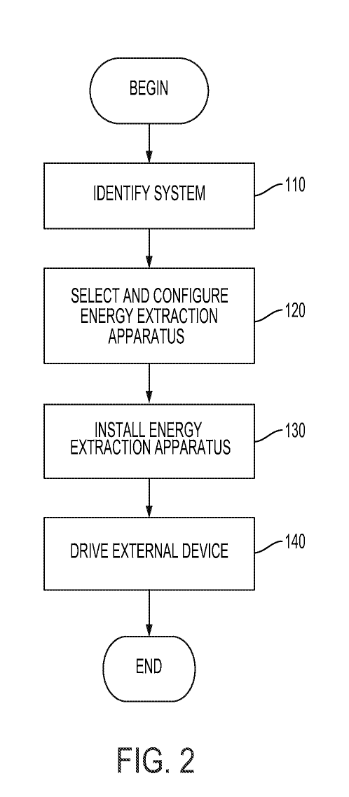

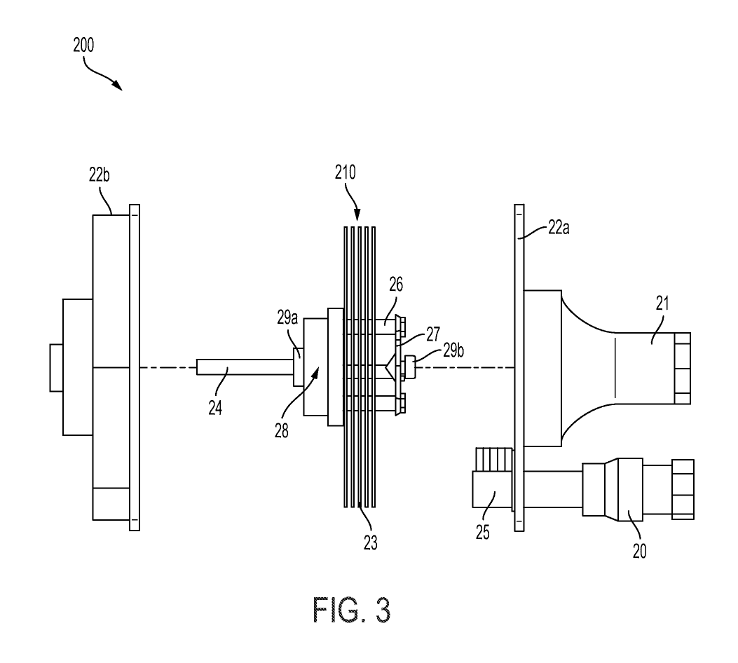

FIG. 2 shows an example of a method for extracting energy, according to principles of the present disclosure. The method begins with identifying a system where fluid flow contains excess energy that can be extracted, or where localized energy production is advantageously created from a fluid flow rather than from, for example, connections to a building electrical supply (STEP 110). The method includes selecting and configuring an energy extraction apparatus to efficiently extract energy from the fluid flow (STEP 120). For instance, the energy extraction apparatus may be installed in an off-index run location. The energy extraction apparatus may include, for example, a Tesla turbine, the turbine powered fan apparatus 10 (shown in FIG. 1), a turbine assembly 200 (shown in FIG. 3), or the like. Once the system and energy extraction apparatus are determined, the apparatus may be installed in the system in the path of the fluid flow to convert kinetic energy in the fluid into rotational energy at a shaft (STEP 130). The installed apparatus may then be used to drive a work-performing device (not shown), such as, for example, a fan, a generator, and the like (STEP 140). The installed apparatus may include a drive shaft that may be coupled to the work-performing device.

In the case that the work-performing device is a generator, the work-performing device may be coupled to a conventional electrical component (such as, for example, a light, a fan, a computer, a television, a clock, a radio, or the like) to supply electrical power to the component. The work-performing device may be configured to supply power to, for example, the electrical power supply, so as to reduce demand on externally supplied electrical power, such as from an electrical power grid.

FIG. 3 shows an exploded view of an example of a turbine assembly 200 that may be included in the turbine powered fan apparatus 10, shown in FIG. 1. The turbine assembly 200, 210 includes an inlet 20 that may receive and direct a working fluid in a conduit of a fluid circulation system into the turbine housing 22a, 22b. The conduit may be, for example, a water supply line, a HVAC supply line, a steam supply line, a gas supply line, or the like. The working fluid may include water, glycol, refrigerant, steam, natural gas, sewage, crude oil, gray water, or any other fluid used in heat transfer, combustion or other industrial process. Water for use in apartments and hotels or waste water can also provide a fluid flow from which energy can be extracted. An outlet 21 returns the working fluid back into the process or fluid circulation system. The housing 22a, 22b encloses a space surrounding a turbine mechanism 210. The turbine mechanism 210 may include a Tesla turbine mechanism, as seen in FIG. 3. The turbine mechanism 210 may include a plurality of flat, smooth discs 23 (in case of working fluid being natural gas, steam or any other compressible fluid) mounted to a hub 28 with at least one axially located shaft 24 and supported by bearings 29a, 29b. The plurality of flat, smooth discs 23 may comprise an etched surface depending on the type of fluid or its Reynolds number being utilized. The bearings 29a, 29b may be of any type including conventional, ceramic, or magnetic-type bearings, configured to support the turbine mechanism 210 for near frictionless rotation within the housing 22a, 22b. In the disclosed embodiment, the discs 23 include a centrally (axially) located exhaust (discharge) aperture fluidly connected to the outlet 21. The discs 23 may be secured to each other and to the hub 28 in a pre-determined spaced-apart relationship by a plurality of connecting rods 26 and also to plate 27. The connecting rods 26 may be configured in a hydro-foil shape (e.g., an oval type cross-sectional shape) to reduce pressure loss. The hub 28 and/or plate 27 may be configured to act as a “flywheel” to provide a desired inertial property during rotation of the turbine mechanism 210. Plate 27 may provide a location to axially support the turbine mechanism 210 on bearing 29b. The turbine mechanism 210 may include an outlet aperture in each disc 23 along the axis of the assembly, maximizing the length of a spiral path of contact between the working fluid and the discs 23.

Those skilled in the art will recognize that the configuration of the turbine mechanism 210 can be optimized for the specific fluid circulation system in which it is employed. For instance, Tesla turbines depend upon two fundamental properties of all fluids—adhesion and viscosity. The specific operation of these two properties in the context of a Tesla turbine is well-known and will be described in detail herein. These two properties may work together in the turbine mechanism 200 to transfer energy from the fluid to a rotor, or vice versa.

The different properties of various working fluids should be taken into account when designing a turbine mechanism, such as, for example, a Tesla turbine. The input flow rate and pressure, acceptable output flow rate and pressure, as well as the desired rotational speed and torque to be generated by the turbine are also factors that should be considered in designing an energy extraction apparatus according to the present disclosure. By way of non-limiting examples, the inner and outer diameter and thickness of the discs 23, the spacing between the discs 23, the number of discs 23, and the configuration of the nozzle 25 and exhaust apertures and outlet 21 all affect the operational characteristics of the turbine mechanism 210 and can be adjusted to maximize the efficiency of energy extraction for a given fluid circulation system while providing a pre-determined rotational speed and torque. The materials from which the discs are constructed will also impact turbine operation, with thin, flat, rigid, smooth metal discs or discs with micro channel surface that resist deformation at high rotational speeds being the most desirable. Composite materials reinforced with, for example, Kevlar or carbon fiber have been successfully employed in the construction of Tesla turbines. However, use of ceramic or glass reinforced materials is also recommended. It is likely that most fluid circulation systems will employ standard fluids such as water or air and have fluid flow and pressure characteristics that fall within a finite range, so a relatively small number of energy extraction apparatuses may be configured to be compatible with a majority of systems.

Such discs can be constructed with smooth, flat, parallel surfaces as are commonly known from the original design of the Tesla turbine apparatus. Alternatively, each disc may be surface treated to increase coarseness of the surface for specific fluids, each disc can be of variable thickness so that the spacing between adjacent disc surfaces grows or reduces with an increase of thickness of the boundary layer between two adjacent discs. The disc surface may also vary in terms of the angular orientation of the disc surface relative to the direction of fluid flow. An aspect of the disclosure is to vary the size of the disc exhaust (discharge) apertures to account for fluid flow through the turbine, and also to match the turbine operational characteristics to a particular working fluid and fluid circulation system. For instance, the discharge aperture of a first disc may receive a lower volume of fluid than the discharge aperture of a disc downstream (e.g., tenth disc). Variability of the discharge aperture is useful for some fluids while not for the others.

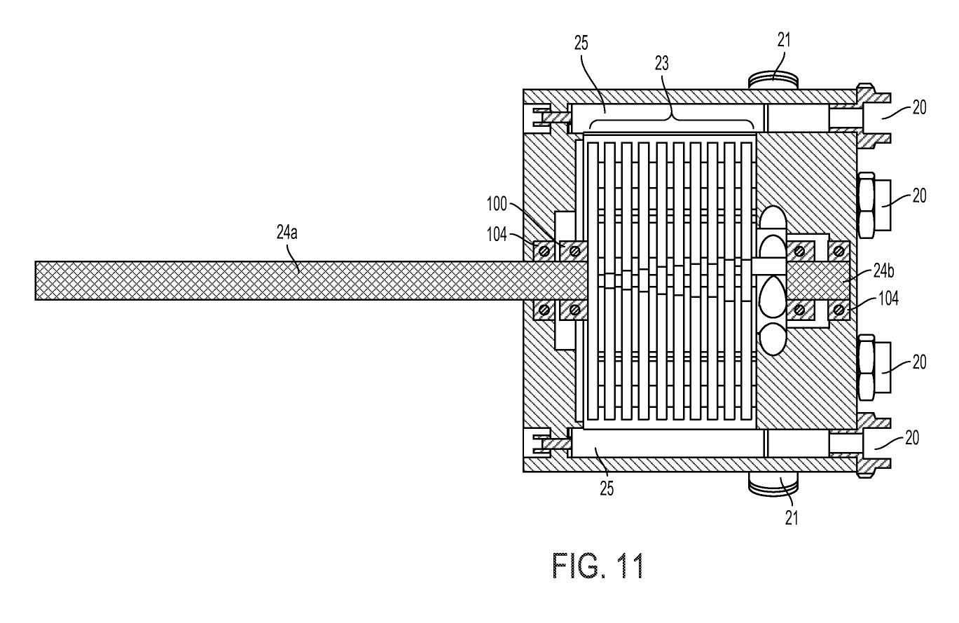

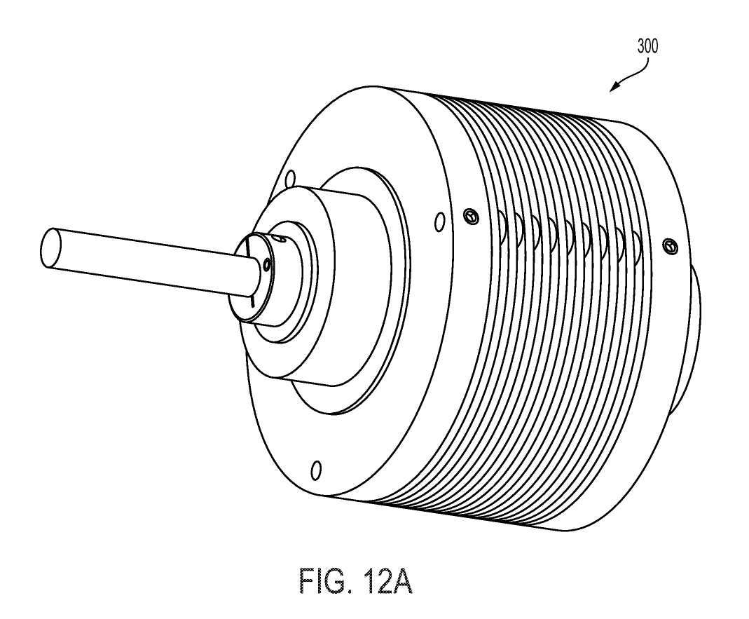

FIGS. 10 and 11 illustrate a non-limiting example of a turbine mechanism constructed according to the principles of the disclosure. Referring to FIGS. 10 and 11, the turbine mechanism may include discs 23a-23j (singularly or collectively referred to as “23”) having axial exhaust openings 51 that are configured larger at the exhaust end of the turbine than at the inlet end, as shown in FIG. 10. An objective of the disclosure is to efficiently harvest energy from the working fluid with minimal pressure drop. A further aspect of the disclosure relates to the use of a plurality of nozzles to introduce fluid at regular intervals around the perimeter of the discs 23. Such an arrangement may “feed” the boundary layer and maintain maximum velocity of fluid (and discs) therefore maximizing force that is transferred from fluid to the discs and improve efficiency of the turbine by allowing for maximized adhesion and effective utilization of the available fluid flow.

Alternatively, as described earlier, for some fluids like water, it is evident that a ratio of outer to inner diameter of the discs is high, in order to maximize effectiveness of such turbine. Contrary to compressible fluids, the velocity of the incompressible fluid between the discs will reduce rapidly with the length of path such fluid spends within the disc arrangement. Therefore, having “rings” as opposed to “discs” will further improve the efficiency of the turbine by maximizing velocity of the fluid between such discs. Having multiple entry points of high velocity fluid (nozzles) to collocate with minimum acceptable fluid velocity within the discs will maximize the efficiency of such turbine. In some embodiments, at least one of the plurality of discs may be a ring with a small outer diameter to inner diameter ratio, such as, e.g., a ratio of less than about 2″.

The disc spacing is critically important for the efficiency of the turbine. As the Reynolds number of fluid between the discs needs to be as low as possible, while initial velocity of the fluid needs to be as high as possible to achieve desired RPM, a compromise must be reached to reduce the Reynolds number. Spacing between the discs can be as small as it can be measured in nanometers or micrometers therefore use of nano or micro technology to maximize the efficiency of the Tesla turbine is quite feasible therefore providing increased contact surface area between the fluid and the discs for energy transfer between them.

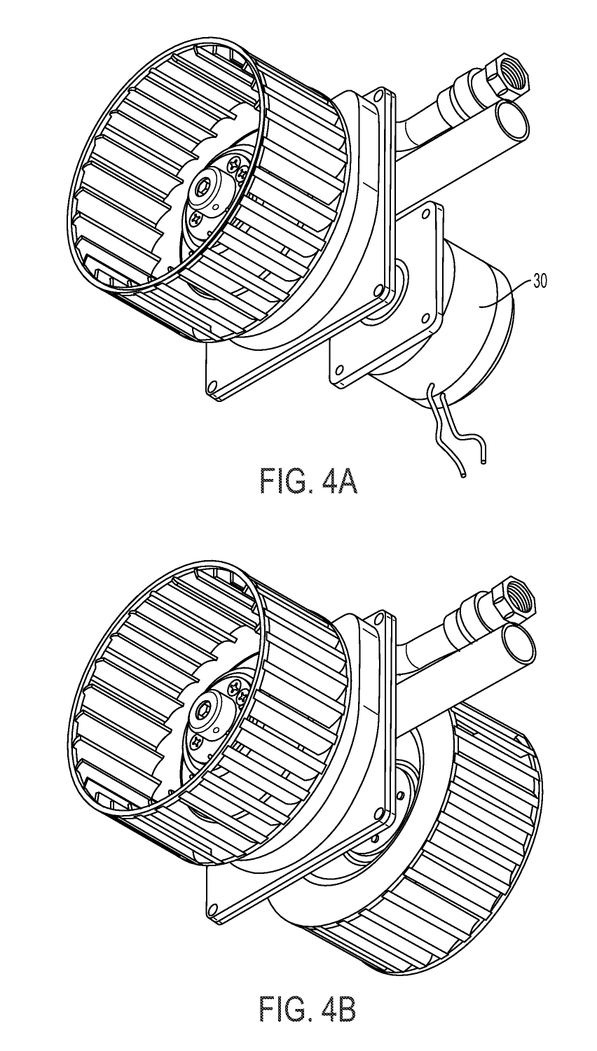

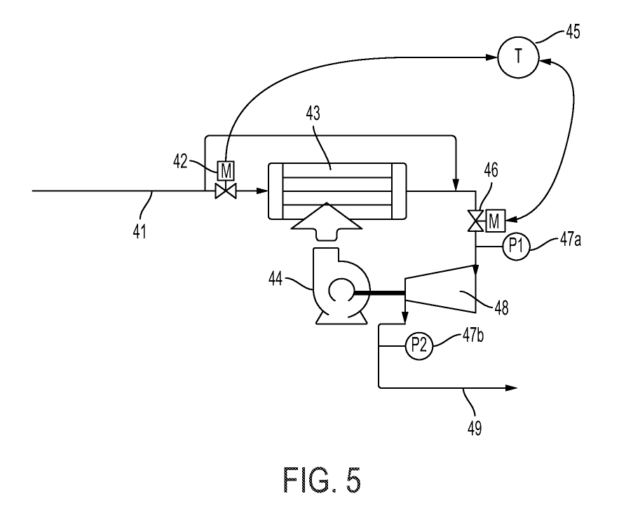

As seen in FIGS. 1, 10 and 11, the turbine apparatus may include, respectively, a no shaft, single shaft 24, or a plurality of shafts extending in both axial directions, as seen in FIGS. 4A and 4B. An embodiment with two shafts enables connection of, for example, one or multiple impeller fans, a fan and power generating equipment, or any combination thereof. The shaft(s) 24 are intended to be a non-limiting example of a coupling mechanism between the rotational force generated by the discs 23 under the influence of the working fluid and a work-performing device, such as, e.g., a fan, a generator, or the like. Other arrangements are contemplated, including providing a coupling on or near plate 27 or hub 28 for transfer of rotational force from the turbine mechanism to perform work. The coupling could be geared, magnetic, friction or other suitable arrangement. The work can be performed directly by rotationally coupling the turbine apparatus to a fan, as seen in FIGS. 1, 4A and 4B. Rotational force generated by the turbine assembly can be coupled to an electrical generator or alternator 30 (FIG. 4A) to generate electrical energy that can be used contemporaneously or stored in batteries (not shown) for later use. Batteries are one non-limiting example of an energy storage device, which may include any suitable substitute, such as a capacitor, or the like. Alternatively, harvested electrical energy may be delivered to one or more grid-connected inverter devices, for so called “reverse-metering.”

Referring to FIG. 3, to maximize efficiency of the turbine mechanism 210, the working fluid may be introduced to the turbine housing 22a, 22b via one or more nozzles 25. The nozzle 25 may introduce the working fluid into the housing 22a, 22b at a position, direction and velocity selected to maximize the rotational speed and force of the turbine for a given fluid circulation system, as one of ordinary skill in the art will recognize and understand.

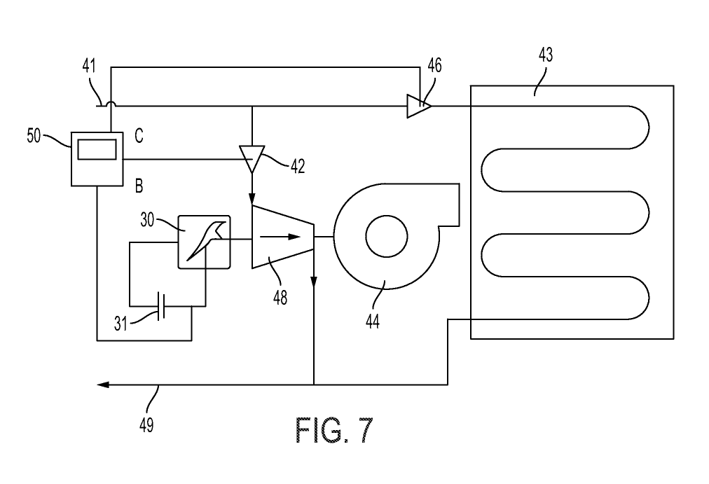

FIG. 6 shows several alternative embodiments of a nozzle compatible with the turbine depicted in FIG. 3. It will be apparent to those skilled in the art that different nozzle configurations, such as those illustrated in FIG. 6, may be employed to maximize the efficiency of energy transfer from the working fluid to the discs 23. Nozzle design and placement may be selected to complement the working fluid, flow characteristics of the fluid circulation system and the physical dimensions and layout of a particular turbine mechanism. It may be possible to “tune” a given turbine assembly using different nozzles, while the remaining dimensions and properties of the turbine remain constant.

In case of the working fluid being water or other incompressible fluid, the nozzle may be configured to maximize the contact between the working fluid and the discs 23 of the turbine, to maximize utilization of the boundary layer effect between the working fluid and the discs.

In case of the working fluid being a gas (a compressible fluid), the nozzle may be configured to maximize the velocity of the working fluid entering the space between the discs 23 using, for example, Venturi, delaval or other fluid dynamic principles.

Alternatively, the configuration, position or angular orientation of the nozzle may be variable to accommodate changes in fluid flow in a given fluid circulation system. A variable configuration nozzle might also be employed to control the speed and torque of the turbine mechanism to match the turbine output with demand for air circulation, to give one non-limiting example. An electronic controller (not shown) may be communicatively coupled through communication links and configured to employ feedback from sensors (not shown), which may be arranged in the fluid circulation system or related HVAC system, to vary the configuration of the nozzles to control the speed of a fan coupled to the turbine, for example. Control of turbine operation may be linear throughout the operational range of, e.g., the fan, or may be provided in steps (low, medium, high).

The rotating output shaft may be coupled to the rotating discs 23 within the turbine via magnetic force. A magnetic coupling may eliminate a need to seal a shaft 24 passing through the turbine housing 22a, 22b and would facilitate discharge of the working fluid, reduce friction forces and improve efficiency of the disclosed energy extraction apparatus. For instance, a plurality of magnets may be embedded in the turbine mechanism to levitate each of the discs with respect to adjacent discs. For example, one or more of the discs may include magnet(s) evenly distributed across a surface of the disc(s).

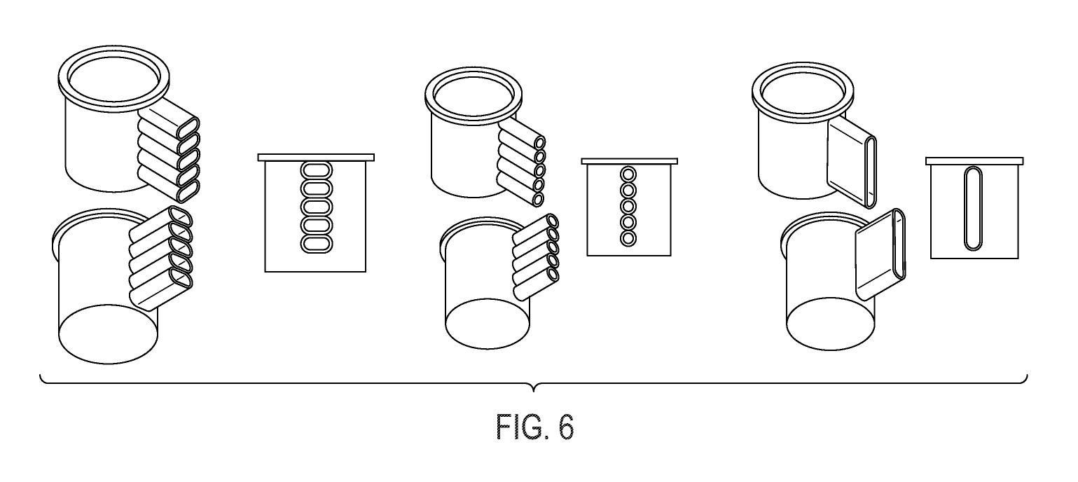

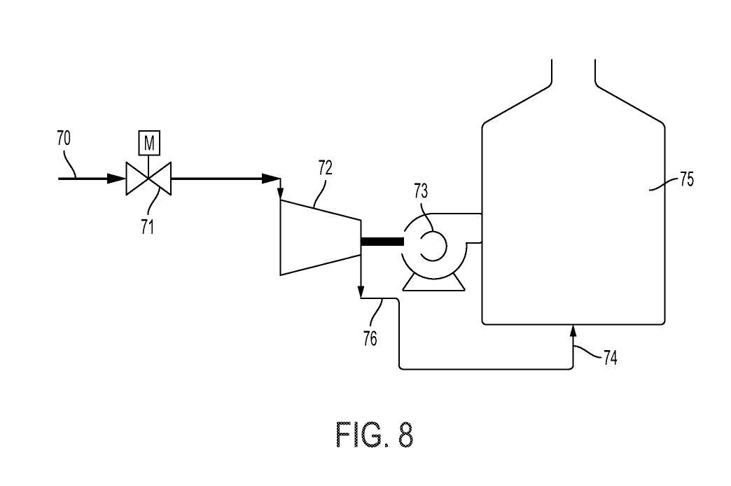

FIG. 5 is a schematic diagram of an arrangement (or system) of an HVAC system utilizing a turbine powered fan apparatus in accordance with the present disclosure. Referring to FIG. 5, the arrangement includes a turbine powered fan 44, 48 with a heat exchanger 43. The system includes a fluid conduit 41 that connects the heat exchanger 43 to a source of working fluid that may include, e.g., water, refrigerant, or the like. The working fluid may be heated or cooled depending upon the desired effect. The system may further include a modulating valve 42 to regulate the flow of working fluid to the heat exchanger 43 according to demand from the related HVAC system, represented by thermostat 45. Working fluid passes from the heat exchanger 43 to a turbine mechanism 48 through another modulating valve 46. Pressure sensors 47a, 47b may be connected at the inlet and discharge of the turbine 48, respectively. Turbine discharge may be connected as a return side of the working fluid circulation system 49, which in the illustrated example is an HVAC system where the working fluid is used to transfer heat energy to and/or from one location to another via heat exchangers 43. A fan 44 may be connected to the turbine 48 to circulate air through the heat exchanger 43. Modulating valves 42, 46 may be connected to the thermostat T or other controller 45. It will be apparent that the rate of flow to the turbine 48 will vary depending upon the state of modulating valves 42, 46. The turbine output may be coupled to a fan, impeller and/or power generating equipment as shown in FIG. 7.

The power generating equipment may be connected to a battery or to a power inverter which can then be connected to, e.g., the power grid, or some combination of energy storage and grid delivery depending upon local energy demand or storage capacity.

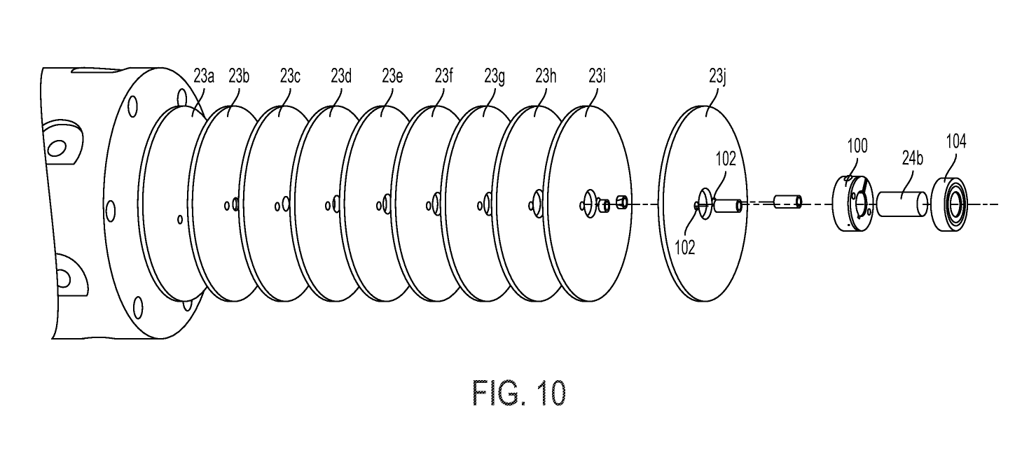

FIG. 9 is a perspective view of an embodiment of a turbine mechanism, according to aspects of the disclosure with the end of the housing and some discs removed for clarity. Referring to FIG. 9, the turbine mechanism includes a housing defining six locations for nozzles 25 that will direct fluid toward the discs 23. Each of the nozzles 25 is configured to be adjustable in terms of the angle at which fluid is directed toward the discs 23. This facilitates tuning or adjusting the performance of the turbine mechanism for operation with specific fluids and other system parameters. The turbine mechanism includes a central shaft 24 extending axially through the length of the turbine and the assembly of discs 23. The discs 23 may be held apart by spacers (and/or magnetic forces) and secured to the shaft 24 by locking collars 100.

FIGS. 10 and 11 show exploded and sectional views of a non-limiting example of a configuration for a turbine mechanism, according to aspects of the disclosure. The turbine mechanism embodiment of FIGS. 10 and 11, as discussed above, employs discs 23a-23j having an exhaust opening 51 at the axial center of each disc. This configuration maximizes fluid contact (and the resulting adhesion) with each disc and has the potential to enhance the efficiency of the turbine. The plurality of discs 23a-23j comprise an outlet aperture that maximizes a length of a spiral path of contact between the moving fluid and a disc. The discs 23a-23j are connected by a pair of rods 103 passing through openings 102 in each disc and coupled to locking collars 100 at each end of the assembly. The locking collars 100 surround and support shaft segments 24a, 24b, which in turn support the rotating turbine parts on bearings 104 at each axial end of the assembly.

The turbine housing for the embodiments illustrated in FIGS. 9-11 have a similar configuration that defines six locations for nozzles 25 and six exhaust openings communicating with outlets 21. Alternative embodiments may employ more or fewer nozzles or outlets. Further, the nozzles may be adjustable in terms of flow volume and the direction in which fluid is directed into the spaces between discs 23. The nozzles 25 may be configured to direct different volumes of fluid at specific locations, depending upon the fluid and requirements of a specific installation. In one non-limiting example, a cone-shaped internal passage in the nozzle would direct a smaller volume of fluid between the last two discs than the first two discs.

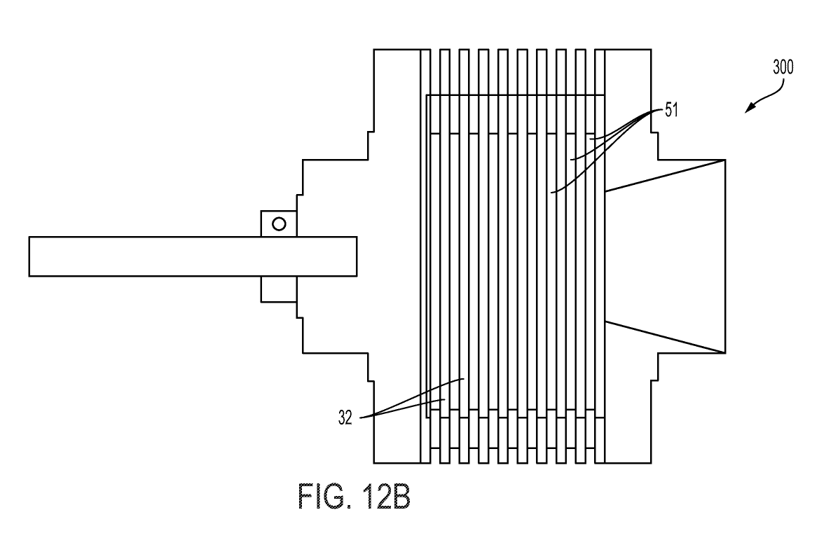

FIG. 12A is a perspective view and FIG. 12B is a cross-sectional view of a rotor embedded in a turbine, configured according to principles of the disclosure. Although the discs 32 may be as described above, in this example, the discs 32 are shown where the aperture 51 is much larger, e.g., about 70% to about 90% of a disc area, or about 90% of a disc 32 area. This configuration may work well with water and other liquid fluids. The disc configuration of FIGS. 10 and 11 tend to work well with gasses.

FIG. 7 depicts an example of an alternative installation of an energy extraction device according to the disclosure. Further to the description provided above with respect to FIG. 5, the illustrated installation includes the turbine 48, an electricity generating device 30, a battery 31, a controller 50, and modulating valves 42, 46. The controller 50 may be connected via electrical conductors to the battery 31 or other energy storage device. The controller 50 is connected via the electrical conductors to the battery for electrical power and to modulating valves 42, 46. The controller 50 may take the form of a thermostatic device or comprise a more advanced microcontroller connected to sensors, feedback loops, or the like. The controller 50 may be configured to communicate with building systems directly through one or more communication links or via a network. A networked controller could permit remote control of the turbine system and allow for data collection from the turbine and related systems to monitor system function and efficiency.

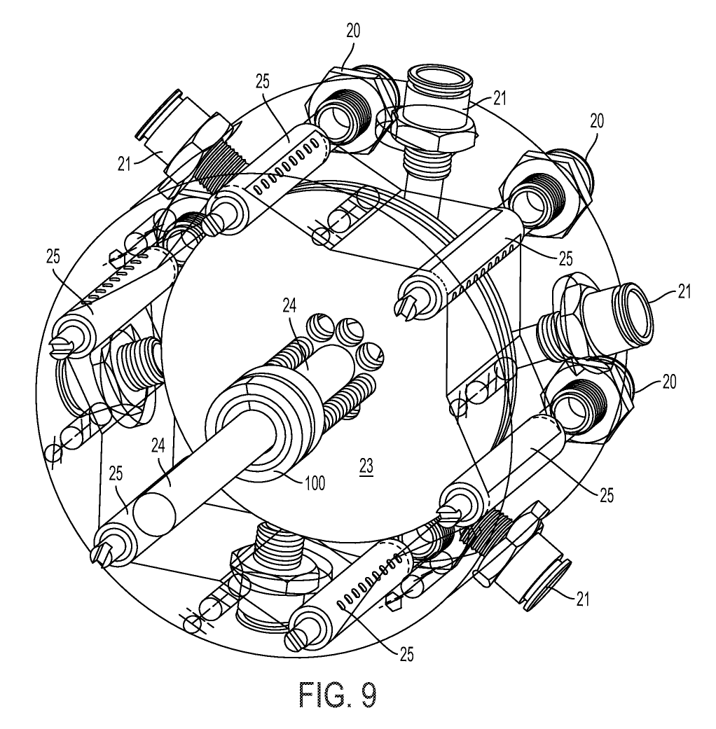

FIG. 8 shows a further alternative application of the disclosed energy extraction apparatus, according to the principles of the disclosure. Referring to FIG. 8, the system includes a turbine powered fan 73 and turbine 72 arranged to provide forced air to a forced draft boiler 75. The turbine 72 is arranged to extract energy from the incoming flow 70 of combustion fluid (natural gas, heating oil, propane, LNG, LPG or other combustible fluids) previously regulated for pressure, and with appropriate safety and control devices is supplied via supply line 70 and flow regulating device 71. Alternatively, the turbine and its associated nozzle may serve the function of a modulating valve 71, providing the necessary pressure drop while extracting energy in the process. The output of the turbine 72 is connected to a fan 73 which introduces air into the burner 74 and/or combustion chamber 75 as required for combustion. The outlet 76 of the turbine powered fan apparatus is connected to the supply line of the burner to supply combustion fluid as required. Advantageously, increased demand for combustion fluid results in a greater fluid flow rate that permits increased air flow from the turbine connected fan 73.

An aspect of the disclosure relates to educational kits that can be used in classroom and lab settings to illustrate the principles of fluid dynamics. One non-limiting example of an educational kit according to the disclosure comprises all the parts of a turbine powered fan apparatus as described in FIG. 3, together with pipes and quick-connect, push-fit or shark-teeth or shark-bite fittings, a set of valves manual (and/or motorized), a controller which may be a micro-processor, a power generator, a display (e.g., an LED display, an LCD display, or LED lights, or the like), a set of electrical wires, a water die, a bucket, water hose, an impeller and a water pump. The kit may be accompanied by printed, digital or on-line materials setting forth experiments designed to illustrate one or more principles of fluid dynamics. The disclosed kits could be used to supplement science and physics courses in grades K-12 private and public schools, at universities or for personal education purposes. The kits can provide insight into basic laws of fluid dynamics, electromagnetism, power generation and sustainability. Additionally, the kits provide students with hands-on, interactive learning experiences that are shown to have long term benefits.

The disclosed energy extraction apparatus can be used in buildings to power fans for the building HVAC system. Energy extraction apparatus may be arranged in mechanical plant-rooms and in spaces where HVAC terminal equipment is located. Buildings where the present invention can be utilized for HVAC purpose include, but are not limited to: residential houses, multi apartment buildings, office buildings, hospitals and medical facilities, institutional and federal buildings, museums, airports, hotels, motels and other entertainment buildings, factories, and the like.

The disclosed energy extraction apparatus can be utilized to generate power from potable water systems, hot or cold water systems, steam heating lines, natural gas supply lines or refrigeration lines, or any other process fluid that may be available, harnessing available energy of the fluids circulating in buildings. To maximize efficiency of energy extraction from the buildings' piping systems, multiple disclosed energy extraction apparatuses can be connected in parallel, as shown in FIG. 13C, to maximize utilization of the available water flow creating a parallel array of turbines. For example, if 100 GPM of water flow is available and the turbine's optimal performance is at 10 GPM. In that case 10 turbines can be connected in parallel to accept full flow available at such location in a building. Assuming that available pressure at such a location in a building is 100 ft of water and a single turbine consumes only 10 ft of water pressure, in that case 10 turbines can be connected in series, as depicted in FIG. 13D, to maximize utilization of available pressure head the pump had already generated. Combination of the two methods of connecting turbines (serial and parallel) can be utilized to maximize utilization of available fluid energy in a building, as shown in FIG. 13E.

Water pumps for commercial applications are typically very large and for tall buildings require significant pressure head. Furthermore, in large chilled water applications, chilled water needs to be circulated at all times to avoid accumulation of sediment and other impurities. The disclosed energy extraction apparatus and methods do not require additional water flow to be circulated within the building. Having already spent energy to pump water throughout the building, the disclosed energy extraction apparatus will utilize the same available fluid flows to operate, without a need to spend additional energy to operate fans, or to generate energy, for example. Water which is already circulated in the building will provide all the energy required to do so.

Assuming a twenty-story building which has 50 fan coil units (FCUs) per floor and each of which consumes 100 W, and the building operating 12 hrs per day for 350 days, or 4200 hrs, the electrical energy consumption to power only fans within FCUs will be 420,000 kWhr. At a rate of 10¢-15¢ per kWhr this amounts to annual energy savings of $42-$65 per FCU. Considering that a building may have 1,000 FCUs, this may lead to potential energy savings of $42,000-$63,000 per annum. A hotel or a hospital with 1000 rooms with a fan coil unit in each room operates 24/7/365 and consumes 876 MWhr per annum. Conversion to the Turbine powered fan apparatus will lead to potential energy savings of $87,600-$130,000 per annum. Significant savings in the electrical installation costs can be achieved as the present disclosure does not require any connection to electrical power. Electrical installation cost savings range significantly—from $500 to more than a $1,000 per FCU leading to initial cost savings in the above examples of $500,000 to more than a $1,000,000.

FIG. 13B illustrates an alternate embodiment of a multi-floor structure with turbines, configured according to principles of the disclosure. The turbine 320 may be any of the turbines described herein, per FIGS. 13C-13E. The turbines 320 may be located on different floors. The turbines 320 and fan coils 325 may be connected to balancing valves 340, a pump 330 and a boiler 335.

FIG. 13C illustrates turbines arranged in parallel, configured according to principles of the disclosure. FIG. 13D illustrates turbines arranged in series, configured according to principles of the disclosure. FIG. 13E illustrates turbines arranged both in parallel and series, configured according to principles of the disclosure. The configuration as of FIGS. 13C-13E may be implemented in similar fashion as shown in relation to FIG. 13A and 13B, including pump 330, boiler 335, balancing valves 340 and fan coils 325.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. An energy extraction system located at off-index run locations of a fluid circulation system for harvesting energy in a moving fluid in a conduit, the energy extraction system comprising:
at least one turbine assembly that includes a housing and a plurality of discs to harvest kinetic energy from the moving fluid;
an inlet that receives and directs the moving fluid from the fluid conduit into the turbine housing to drive the plurality of discs; and
an outlet that returns the moving fluid from the turbine housing to the fluid conduit,
wherein at least one of the plurality of discs comprises an outlet aperture that optimizes a length of a spiral path of contact between the moving fluid and a disc.

2. The system of claim 1, wherein the at least one turbine assembly comprises a hub including a plurality of nozzles configured to discharge the moving fluid at a specific location to the plurality of discs and at a specific angle to an axis of rotation of the plurality of discs to maximize turbine efficiency.

3. The system of claim 2, wherein the turbine housing comprises a flywheel to provide inertial energy during rotation of the plurality of discs.

4. The system of claim 1, wherein the moving fluid comprises:
water;
a glycol;
a refrigerant;
a crude oil;
sewage;
gray water;
a steam;
a gas; or
any other non-Newtonian fluid.

5. The system of claim 1, wherein the at least one turbine assembly comprises at least one Tesla turbine.

6. The system of claim 1, wherein the at least one turbine assembly comprises multiple turbines connected in parallel to fully utilize available fluid flow.

7. The system of claim 1, wherein the at least one turbine assembly comprises multiple turbines connected in series to fully utilize available fluid pressure head.

8. The system of claim 1, wherein the at least one turbine assembly comprises multiple turbines connected in parallel to fully utilize available fluid flow and connected in series to achieve desired pressure drop.

9. The system of claim 1, wherein at least one of the plurality of discs has a flat, smooth surface, or at least one of the plurality of discs has an etched surface depending on the fluid being utilized and associated Reynolds number of the fluid.

10. The system of claim 1, wherein at least one of the plurality of discs is a ring with a outer diameter to inner diameter ratio of less than about 2″.

11. The system of claim 1, wherein each of the plurality of discs comprises magnetic elements to maintain the discs in a spaced relationship.

12. The system of claim 1, wherein the at least one turbine assembly comprises a shaft that transfers the kinetic energy harvested from the moving fluid to rotational energy.

13. The system of claim 1, wherein the at least one turbine assembly comprises a shaft that transfers the kinetic energy harvested from the moving fluid to rotational energy where such shaft comprises of magnetic bearings to maximize efficiency of the turbine assembly.

14. The system of claim 13, further comprising a work-performing device coupled to the shaft and configured to receive the rotational energy.

15. The system of claim 14, wherein the work-performing device comprises a fan.

16. The system of claim 14, wherein the work-performing device comprises a generator.

17. The system of claim 1, wherein the circulation system comprises a building HVAC system and the index run is configured to provide fluid flow to a designated highest pressure loss branch in a piping system of the building, sufficient to meet at least a demand for heating and cooling by every heat exchange unit on that branch.

18. The system of claim 1, wherein the at least one turbine assembly comprises at least one nozzle that directs the moving fluid from the inlet to at least one of the plurality of discs to increase a velocity of the moving fluid.

19. The system of claim 1, wherein a spacing between the plurality of discs maximizes the contact surface between the moving fluid and the plurality of discs, wherein the spacing is either at the micro-scale or nano-scale.

20. A method for harvesting energy in a moving fluid in a conduit of a fluid circulation system in series with a balancing valve, the method comprising:
identifying an off-index run location of the circulation system for installing an energy extraction apparatus;
coupling an inlet of the energy extraction apparatus to a portion of the conduit to receive the moving fluid from the conduit; and
coupling an outlet of the energy extraction apparatus to another portion of the conduit to return the moving fluid to the conduit,
wherein the energy extraction apparatus comprises a turbine assembly to harness kinetic energy of the moving fluid in the conduit and convert the harnessed kinetic energy to a rotational energy.

21. The method of claim 20, wherein the turbine assembly comprises a housing and a plurality of discs configured to harvest kinetic energy from the moving fluid.

22. The method of claim 21, wherein at least one of the plurality of discs comprises an outlet aperture that optimizes a length of a spiral path of contact between the moving fluid and a disc.

23. The method of claim 20, wherein the turbine assembly comprises a hub including a plurality of nozzles configured to discharge the moving fluid at a specific location to the plurality of discs and at a specific angle to an axis of rotation of the plurality of discs to maximize turbine efficiency.

24. An energy extraction apparatus for coupling to an off-index run location of a fluid circulation system to harvest kinetic energy in a moving fluid in a conduit, the energy extraction apparatus comprising:
at least one turbine assembly that includes a housing and a plurality of discs to harvest kinetic energy from the moving fluid;
an inlet that receives and directs the moving fluid from the fluid conduit into the turbine housing to drive the plurality of discs; and
an outlet that returns the moving fluid from the turbine housing to the fluid conduit.

25. The energy extraction apparatus of claim 24, wherein at least one of the plurality of discs comprises an outlet aperture that maximizes a length of a spiral path of contact between the moving fluid and a disc.

26. The energy extraction apparatus of claim 24, wherein the turbine assembly comprises a hub and wherein the plurality of discs are secured to each other and to the hub in a spaced relationship.

27. The energy extraction apparatus of claim 24, wherein the at least one turbine assembly comprises multiple turbines connected in parallel to fully utilize available fluid flow and connected in series to achieve desired pressure drop.
